(19) United States
(12) Patent Application Publication
(10) Pub. No.: US 2009/0029196 A1
(43) Pub. Date: Jan. 29, 2009

(54) Dry method of making a gas diffusion electrode

(75) Inventors: Gennadi Finkelshtain, Shoham (IL); Avraham Melman, Holon (IL); Jacob Rosenberg, Jerusalem (IL)

Correspondence Address: GREENBLUM & BERNSTEIN, P.L.C., 1950 ROLAND CLARKE PLACE, RESTON, VA, 20191, US

(73) Assignee: More Energy Ltd., Lod (IL)

(21) Appl. No.: 11/878,842

(22) Filed: Jul. 27, 2007

(51) Int. Cl. H01M 4/58; H01M 10/44; H01M 8/00

(52) U.S. Cl. 429/13; 29/746; 429/128; 429/231.8; 429/42; 429/50

(57) ABSTRACT

A substantially dry method of making a gas diffusion electrode such as, e.g., an air cathode for a fuel cell or a metal-air battery cell. The method comprises forming an intimate mixture of catalytically active carbon particles and particles of a wet-proofing agent into a web; combining under pressure the web of with a current collector to form a current collector-web composite; and attaching a porous sheet of a fluorinated polymer to one side of the current collector-web composite of to form an air cathode. This Abstract is not intended to define the invention disclosed in the specification, nor intended to limit the scope of the invention in any way.

### BACKGROUND OF THE INVENTION

1. Field of the Invention

The present invention relates to a dry method of making a high current density gas diffusion electrode and in particular, an air cathode for a power source such as a fuel cell or a metal-air battery. The invention also relates to a gas diffusion electrode which is obtainable by this method and a fuel cell and a metal-air battery which contain the gas diffusion electrode.

2. Discussion of Background Information

Fuel cells are electrochemical power sources wherein an electrocatalytic oxidation of a fuel (for example, molecular hydrogen, methanol or a metal (boro)hydride) at an anode and electrocatalytic reduction of an oxidant (often molecular oxygen) at a cathode take place simultaneously. Borohydride-(and other hydride) based fuels are of particular interest for portable fuel cells, due to their very high specific energy capacity.

For example, the main oxidation reaction at the anode of a fuel cell which uses a borohydride compound as a fuel can be represented as follows:

BH₄⁻+8 OH⁻═BO₂⁻+6 H₂O+8 e⁻.

The main reduction reaction at the cathode in the case of air (oxygen) as the substance to be reduced at the cathode can be represented as follows:

2 O₂+4 H₂O+8 e⁻═8 OH⁻.

In this case, the overall reaction can be represented as follows:

BH₄⁻+2 O₂═BO₂⁻+2 H₂O.

Metal-air batteries are commonly used electrical energy sources and have a lot in common with fuel cells. Like a fuel cell, a metal-air battery comprises a cathode, an anode and an electrolyte. The anode of a metal-air battery comprises an active material that can be oxidized. The cathode consumes an active material that can be reduced. The anode active material is capable of reducing the cathode active material. In a metal air battery molecular oxygen is reduced at the cathode and a metal is oxidized at the anode. Oxygen is supplied to the cathode from the atmospheric air external to the battery through one or several air ports in the battery housing.

Metal-air batteries are characterized by a high energy density, a flat discharge voltage and long shelf life. They are environmentally safe when properly disposed and available at a relatively low cost. In the past, larger metal-air batteries using zinc were used in railroad applications, communications, and other applications requiring long life and a low rate of battery discharge. Smaller metal-air batteries of this type find use in items such as pagers and hearing aids. Zinc is a commonly used metal for use in metal-air batteries. Other metals such as lithium, calcium, magnesium, aluminum and iron are also frequently used in metal-air batteries. Aluminum-air batteries comprising neutral electrolytes are frequently used in portable equipment and marine applications, and those comprising alkaline electrolytes are often used for items such as emergency power supplies and field-portable batteries.

Air cathodes of metal-air batteries and fuel cells are often made of porous carbon structures. An air cathode is usually made by a wet method such as, e.g., a method which involves the dispersion of catalytically active particles such as carbon particles in a solvent such as water and/or an alcohol, optionally together with a binder such as polyvinyl alcohol and/or particles of a fluorinated polymer such as PTFE to form a paste, the application of the paste onto a carrier such as, e.g., carbon paper, and the combination thereof with a current collector such as a metal mesh or grid, followed by a drying operation to remove the solvent.

It would be desirable to have available a method of producing a gas diffusion electrode such as, e.g., an air cathode by a dry method, i.e., a method in which the use of a solvent can be dispensed with and which therefore, avoids the disadvantages associated with the use of a solvent (e.g., the need to remove the solvent and the environmental and other (e.g., fire hazard) problems when a solvent different from water is used).

### SUMMARY OF THE INVENTION

The present invention provides a substantially dry method of making a gas diffusion electrode such as, e.g., an air cathode for a fuel cell or a metal-air battery. The method comprises
(a) forming an intimate mixture (e.g., fibrillating a mixture) of catalytically active carbon particles and particles of a wet-proofing agent into a web;
(b) combining under pressure the web formed in (a) with a (sheet-like) current collector to form a current collector-web composite; and
(c) attaching a porous sheet of a fluorinated polymer to one side of the current collector-web composite of (b) to form a gas diffusion electrode.

In one aspect, the method may be carried out in the substantial absence of added solvent.

In another aspect, the intimate mixture employed in (a) may have been prepared by treating a mixture of the catalytically active carbon particles and the fluorinated polymer particles in a milling machine and/or a chopping machine and/or a beating machine. In another aspect, the intimate mixture may have been prepared in the substantial absence of added solvent.

In another aspect of the method of the present invention, the catalytically active carbon particles may comprise carbon particles which support a catalytically active material, for example, a catalytically active metal such as, e.g., Co, Mn and/or Ag. By way of non-limiting example, the catalytically active material (metal) may be present in a concentration of from about 0.1% to 10% by weight, based on the total weight of the carbon particles and the catalytically active material.

In yet another aspect, the catalytically active carbon particles may have an average particle size of from about 1 μm to about 100 μm and/or a specific surface area of at least about 200 m²/g. For example, the catalytically active carbon particles may have an average particle size of from about 6 μm to about 50 μm and/or a specific surface area of from about 300 m²/g to about 1000 m²/g.

In a still further aspect, the intimate mixture may further comprise pore-forming particles which have an average particle size of from about 1 μm to about 100 μm and a specific surface area of from about 500 m²/g to about 2000 m²/g. For example, the pore-forming particles may comprise electrically conductive particles such as, e.g., carbon particles or particles of a conductive organic (polymeric) or inorganic material.

In another aspect of the method, the particles of a wet-proofing agent may comprise fluorinated polymer particles such as, e.g., particles of a fluorinated hydrocarbon polymer. For example, the fluorinated hydrocarbon may comprise a fluorinated ethylene (such as, e.g., tetrafluoroethylene) and/or a fluorinated propylene (such as, e.g., hexafluoropropylene).

In another aspect, the fluorinated polymer particles may have an average particle size of from about 10 μm to about 500 μm.

In yet another aspect of the method of the present invention, the intimate mixture of (a) may comprise from about 30% to about 95% by weight of the catalytically active carbon particles and from about 5% to about 35% by weight of the particles of the wet-proofing agent, and optionally, up to about 65% by weight of the pore-forming particles, all based on the total weight of the mixture.

In another aspect, the web of (a) may have a thickness of from about 0.2 mm to about 0.6 mm.

In yet another aspect, the current collector employed in (b) may comprise a metal mesh and/or a metal grid and/or a metal cloth and/or a metal foam. In another aspect the current collector may comprise Ni. For example, the current collector may comprise a mesh or cloth having a thickness of from about 0.12 mm to about 0.4 mm and/or a metal foam having a thickness of from about 0.5 mm to about 2 mm.

In another aspect of the present method, stage (b) thereof may comprise passing the web and the current collector together through a calender. By way of non-limiting example, the resultant current collector-web composite may have a thickness of from about 0.2 mm to about 0.6 mm.

In another aspect of the present method, the sheet of a fluorinated polymer may comprise polytetrafluororethylene and/or may have a thickness of from about 0.1 mm to about 0.35 mm and/or may have an average pore size of from about 0.05 μm to about 2 μm. For example, the sheet of fluorinated polymer may be laminated to the current collector-web composite.

In a still further aspect of the present method, the gas diffusion electrode formed thereby may have a thickness of from about 0.25 mm to about 0.75 mm.

The present invention also provides a substantially dry method of making an air cathode for a fuel cell or a metal-air battery cell. The method comprises
(a) forming a fibrillated mixture of, based on the total weight of the mixture,
   (i) from about 40% to about 60% by weight of catalytically active carbon particles having an average particle size of from about 6 μm to about 50 μm and/or a specific surface area of from about 300 m²/g to about 1000 m²/g.
   (ii) from about 5% to about 20% by weight of particles of a fluorinated hydrocarbon polymer, and
   (iii) from about 40% to about 55% by weight of pore-forming carbon particles having an average particle size of from about 10 μm to about 50 μm and/or a specific surface area of from about 800 m²/g to about 1500 m²/g
   into a web having a thickness of from about 0.35 mm to about 0.55 mm;
(b) calendering the web of (a) together with a current collector which comprises a metal mesh and/or a metal grid and/or a metal cloth and/or a metal foam to form a current collector-web composite having a thickness of from about 0.35 mm to about 0.5 mm;
(c) laminating a porous PTFE sheet having a thickness of from about 0.15 mm to about 0.2 mm and/or an average pore size of from about 0.05 μm to about 2 μm to one side of the current collector-web composite of (b) to form an air cathode having a thickness of from about 0.35 mm to about 0.55 mm.
   The method is carried out in the substantial absence of solvent.

In one aspect of the method, the fibrillated mixture of (a) may have been prepared by treating a mixture of the above particles (i) to (iii) in a milling machine and/or a chopping machine and/or a beating machine.

In another aspect, the particles (i) may comprise carbon particles which support a catalytically active metal such as, e.g., one or more of Co, Mn and Ag. For example, the catalytically active metal may be present in a concentration of from about 0.1% to 10% by weight, based on the total weight of the carbon particles and the catalytically active metal.

In another aspect of the method, the fluorinated polymer particles may comprise particles of a polymer of a fluorinated ethylene and/or a fluorinated propylene. For example, the fluorinated polymer particles may comprise polytetrafluoroethylene.

In another aspect of the method, the current collector may comprise Ni.

The present invention also provides an air cathode which is obtainable by a method of the present invention as set forth above (including the various aspects thereof) and a fuel cell (e.g., a direct liquid fuel cell and/or a portable fuel cell) and a metal-air battery which comprises the air cathode.

In one aspect, the cathode may have a surface area of from about 0.5 cm² to about 200 cm².

### BRIEF DESCRIPTION OF THE DRAWINGS

The present invention is further described in the detailed description which follows, in reference to the drawings wherein:

FIG. 1 represents polarization curves (volts vs. current density) obtained after different times of use of the air cathode prepared in Example 1 below; and

FIG. 2 shows a device which is used to obtain the data represented in FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

As set forth above, the substantially dry method of the present invention comprises the initial forming of an intimate mixture of catalytically active carbon particles, particles of a wet-proofing (hydrophobic) agent and, optionally, pore-forming particles into a web. The intimate mixture may be produced, for example, by combining the corresponding powders, optionally followed by a short manual mixing to break up lumps of material which may have formed at the weighing stage, and loading the powder mixture into a suitable apparatus such as, e.g., a milling and/or chopping and/or beating machine. The mixture may then be processed in the apparatus to fibrillate it to a pre-determined fibrillation level. For example and merely by way of illustration, 30 g of mixture may be processed at room temperature in a milling machine M-20 (available from IKA Works, Inc., Wilmington, N.C.) at 30 krpm (tip speed 72 m/sec) for 90 seconds. The mixing and processing is preferably done in the substantial absence of solvent (liquid). In other words, the particles are substantially dry (for example, having a content of water or other solvent of not more than about 5% by weight, e.g., not more than about 2% by weight, not more than about 1% by weight or not more than about 0.5% by weight) and no solvent is added to the particles.

The catalytically active carbon particles may be catalytically active as such (i.e., capable of catalyzing the reduction of, e.g., molecular oxygen in a fuel cell or a metal-air battery) and/or may serve as a support for a material which is capable of catalyzing the reduction of, e.g., molecular oxygen in a fuel cell or a metal-air battery. Non-limiting examples of materials which are capable of catalyzing the reduction of molecular oxygen include noble metals and non-noble transition metals such as, e.g., one or more of Co, Mn, Ni, Pt, Pd, Ag and Au, in particular, Co, Mn and Ag. If the carbon particles comprise a catalyst the catalyst will usually be present in a concentration of at least about 0.1% by weight, e.g., at least about 0.5% by weight, at least about 1% by weight or at least about 2% by weight, but not more than about 20% by weight, e.g., not more than about 15% by weight or not more than about 10% by weight.

The catalytically active carbon particles will usually have an average particle size (for example, as determined by sieve analysis) of at least about 1 μm, e.g., at least about 2 μm, at least about 5 μm or at least about 6 μm, but not higher than about 100 μm, e.g., not higher than about 80 μm, not higher than about 70 μm, not higher than about 60 μm or not higher than about 50 μm.

Further, the catalytically active carbon particles will usually have a surface area of at least about 200 m²/g, e.g., at least about 250 m²/g or at least about 300 m²/g, but not more than about 1500 m²/g, e.g., not more than about 1200 m²/g or not more than about 1000 m²/g. A non-limiting example of a commercially available catalytically active carbon powder which is suitable for use in the method of the present invention is SX1-G (available from Norit Americas Inc., Marshall, Tex.). A non-limiting example of a commercially available catalytically inactive carbon powder which may be used as a catalyst carrier for use in the method of the present invention is HSAG300 (inactive graphite powder available from Timcal Graphite & Carbon, Westlake, Ohio).

The catalytically active carbon particles will usually be present in the mixture in a concentration of at least about 30% by weight, e.g., at least about 35% by weight or at least about 40% by weight, but not more than about 95% by weight, e.g., not more than about 90% by weight, not more than about 80% by weight, not more than about 70% by weight or not more than about 65% by weight. Of course, two or more different catalytically active carbon powders may be used in combination.

The particles of the wet-proofing agent preferably comprise fluorinated polymer particles such as, e.g., particles which comprise a fluorinated hydrocarbon polymer (e.g., PTFE and/or FEP particles). Non-limiting examples of the fluorinated hydrocarbon include one or more fluorinated (in particular, perfluorinated) olefins such as, e.g., (per)fluorinated ethylene, propylene, butene-1, butene-2, 1-pentene, 1-hexene and 1-octene. Specific examples thereof include tetrafluoroethylene and hexafluoropropene.

The particles of the wet-proofing agent will usually have an average particle size (for example, as determined by sieve analysis), of at least about 10 μm, e.g., at least about 20 μm, at least about 35 μm or at least about 50 μm, but not higher than about 500 μm, e.g., not higher than about 300 μm, not higher than about 200 μm or not higher than about 100 μm. A non-limiting example of a commercially available powder of the wet-proofing agent is a PTFE powder TF2055 which is available from Dyneon (a 3M company).

The particles of the wet-proofing agent will usually be present in the mixture in a concentration of at least about 5% by weight, e.g., at least about 7% by weight or at least about 10% by weight, but not more than about 35% by weight, e.g., not more than about 30% by weight, not more than about 25% by weight or not more than about 20% by weight. Of course, two or more different wet-proofing agent powders may be used in combination.

The optionally employed pore-forming particles preferably comprise electrically conductive particles such as, e.g., carbon particles. However, other electrically conductive organic (polymeric) or inorganic materials may be used as well. If carbon particles are used, the carbon particles may be the same as those used for the catalytically active carbon particles but without a catalyst supported thereon. The pore-forming particles will usually have an average particle size (for example, as determined by sieve analysis) of at least about 1 μm, e.g., at least about 5 μm, at least about 8 μm or at least about 10 μm, but not higher than about 500 μm, e.g., not higher than about 400 μm, not higher than about 300 μm, not higher than about 200 μm or not higher than about 100 μm.

Further, the pore-forming particles will usually have a surface area of at least about 500 m²/g, e.g., at least about 600 m²/g, at least about 700 m²/g or at least about 800 m²/g, but not more than about 2000 m²/g, e.g., not more than about 1800 m²/g or not more than about 1500 m²/g. Non-limiting examples of commercially available pore-forming powders include SX1G carbon powder (available from Norit Americas Inc., Marshall, Tex.) and Anthralur KC activated carbon (available from Donau Carbon Corporation of Springfield, N.J.).

The pore-forming particles, if employed, will usually be present in the mixture in a concentration of at least about 30% by weight, e.g., at least about 35% by weight or at least about 40% by weight, but not more than about 65% by weight, e.g., not more than about 60 % by weight, or not more than about 55 % by weight. Of course, two or more different pore-forming powders may be used in combination.

The intimate mixture of catalytically active carbon particles, particles of the wet-proofing agent and, optionally, pore-forming particles is formed into a web by applying pressure to the mixture by, for example, a calender. By way of non-limiting example, a web having a thickness of about 450 μm may be produced when the mixture is passed through a gap of 350 μm between the rollers of a calender.

The gas-permeable web produced in stage (a) of the method of the present invention will usually have a thickness of at least about 0.2 mm, e.g., at least about 0.3 mm, at least about 0.35 mm or at least about 0.4 mm, but not higher than about 0.6 mm, e.g., not higher than about 0.55 mm or not higher than about 0.5 mm.

Non-limiting examples of the current collector which is employed in stage (b) of the method of the present invention include a metal mesh, a metal grid, a metal cloth and a metal foam. The metal may, for example, be selected from one or more transition metals such as, e.g., Ni, Co, Cu and Ag. The current collector will often have a thickness of from about 0.1 mm to about 2 mm.

Specific examples of current collectors which are suitable for the purposes of the present invention include those which are made of metals such as, e.g., a woven Ni mesh/cloth having a thickness of from about 0.12 mm to about 0.4 mm, preferably from about 0.18 mm to about 0.3 mm, an expanded Ni mesh or Ni foam having a thickness of from about 0.5 mm to about 2 mm and a Ni or Ag coated Cu mesh. Such materials are commercially available from, for example, Gerard Daniel Worldwide of Hanover, Pa., Haver & Boecker OHG of Oelde, Germany, Dexmet of Naugatuck, Conn., Inco Ltd. of Toronto, Canada, and others.

Moreover, in a particularly advantageous embodiment the current collector is precoated with a paint made of fine graphite particles and some binder, dispersed in an aqueous or an organic solvent. After drying the coating a conducting layer of graphite particles covers the metallic surfaces to ensure long term stability of the electric contact between the web and the current collector. Non-limiting examples of commercially available paints which are suitable for precoating include Dag EB-005 (from Acheson Colloids Company, Ontario, Canada) and Timrex LB 1016 (from Timcal Graphite & Carbon, Westlake, Ohio.

In stage (b) of the method of the present invention the web and the current collector are combined, usually under pressure. By way of non-limiting example, the mesh may at least partially become embedded in the web by passing the web and the current collector together through a calender. For example, a web having a thickness of about 450 μm may be produced when the intimate powder mixture described above is calendered through a gap of about 350 μm between the rollers. A mesh current collector may then (at least partially) be embedded in the web by passing the combination through a gap of about 210 μm between a second set of rollers, producing a current collector mesh composite having a thickness of about 370 μm. In more general terms, the current collector-web composite will usually have a thickness of at least about 0.2 mm, e.g., at least about 0.25 mm, at least about 0.30 mm, at least about 0.35 mm, at least about 0.4 mm or at least about 0.45 mm, but not higher than about 0.6 mm, e.g., not higher than about 0.55 mm or not higher than about 0.5 mm.

In stage (c) of the method of the present invention a porous sheet of a fluorinated polymer is attached, usually under pressure (lamination), to the current collector-mesh composite. The porous sheet, preferably a PTFE sheet, is substantially liquid-impermeable and gas-permeable, i.e., is preferably capable of sealing against leakage of electrolyte through the electrode while allowing penetration of the active gas (e.g., molecular oxygen) into the electrode. It will usually also provide a certain level of control over environmental factors which affect the performance and longevity of the electrode or cell, such as humidity and carbon dioxide in the air.

The porous sheet will usually have a thickness of at least about 100 μm, e.g., at least about 125 μm, or at least about 150 μm, but not higher than about 350 μm, e.g., not higher than about 300 μm, not higher than about 250 μm, or not higher than about 200 μm.

Further, the porous sheet will usually have an average pore size of from about 0.05 μm to about 2 μm. Non-limiting examples of commercially available sheets which are suitable for the purposes of the present invention include the R167 family of PTFE sheets from Saint-Gobain, France.

The gas diffusion electrode obtained by the method of the present invention will usually have a thickness of at least about 0.25 mm, e.g., at least about 0.3 mm, at least about 0.35 mm, at least about 0.4 mm, or at least about 0.45 mm, but not higher than about 0.75 mm, e.g., not higher than about 0.7 mm, not higher than about 0.65 mm, not higher than about 0.6 mm, not higher than about 0.55 mm or not higher than about 0.5 mm. For example and by way of illustration only, a porous PTFE sheet may be laminated to a current collector-web composite by passing the sheet and the composite together through a pair of rollers having a diameter of 65 mm and applying a pressure of about 3 kN.

A suitable PTFE sheet lamination pressure may, for example, be determined by measuring the color of the sheet after pressing (e.g., by using a spectrodensitometer). As the lamination pressure is raised the color of the PTFE sheet turns from white to grey-blue. For example, a typical Cyan color after lamination in the above example is 0.20-0.24 for a sheet having a thickness of 175 μm (determined with a 508 model densitometer made by X-rite, Grand Rapids, Mich.).

As set forth above, the method of the present invention is carried out in the substantial absence of added solvents and therefore is a dry method which substantially avoids the expenditure and problems usually associated with the removal of solvent(s).

The gas diffusion electrode obtained by the method of the present invention may, for example, be employed as an air-breathing cathode of a metal-air battery or a fuel cell and in particular, of a liquid fuel cell. The anode of the fuel cell may be any anode that can be used in a (liquid) fuel cell. Examples thereof are well known to those skilled in the art and include anodes comprising a noble metal such as, e.g., Pt on a electrically conductive carrier such as carbon.

The structure of a typical fuel cell according to the present invention comprises an anode which in its operative state is in contact with a liquid fuel on one side, and is in contact with a liquid, gel or solid electrolyte on its other side, and a cathode which also is in contact with the electrolyte on one side thereof. The other side of the cathode is in contact with a gaseous oxidant, preferably molecular oxygen, air or any other oxygen containing gas.

A liquid fuel for use in a liquid fuel cell of the present invention may be any fuel that is suitable for liquid fuel cells. By way of non-limiting example, the liquid fuel may comprise water and/or a (monohydric or polyhydric) lower alcohol (usually a saturated aliphatic alcohol), in combination with a substance such as, e.g., NaBH₄, KBH₄, LiBH₄, Al(BH₄)₃, Zn(BH₄)₂, NH₄BH₄, (CH₃)₂NHBH₃, NaCNBH₃, a polyborohydride, LiAlH₄, NaAIH₄, CaH₂, LiH, NaH, KH, Na₂S₂O₃, Na₂HPO₃, Na₂HPO₂, K₂S₂O₃, K₂HPO₃, K₂HPO₂, HCOOH, NaCOOH and KCOOH or any combination of two or more thereof. The lower alcohol may, for example, be an alcohol having 1 to 6, e.g., 1 to 4 carbon atoms, and 1 or more, e.g., 1 to 4, OH groups. Non-limiting examples thereof are methanol, ethanol, n-propanol, isopropanol, n-butanol, isobutanol, pentanol, hexanol, ethylene glycol, propylene glycol, glycerol, pentaerythritol and any combination of two or more thereof. The liquid fuel may also comprise a basic compound, e.g., for the purpose of stabilizing the fuel substance. The basic compound may be any suitable organic or inorganic base, for example, an inorganic hydroxide, non-limiting examples whereof are ammonium and (preferably alkali and alkaline earth) metal hydroxides, such as, e.g., NaOH, KOH and LiOH, and NH₄OH.

An electrolyte that is suitable for use in a liquid fuel cell may comprise a base, for example an aqueous inorganic hydroxide. Non-limiting examples of the inorganic hydroxide are alkali metal hydroxides, such as, e.g., NaOH, KOH and LiOH. Non-limiting examples of liquid fuels and electrolytes suitable for use in the fuel cell of the present invention are disclosed, for example, in U.S. Patent Application Publication Nos. 2002/0083640, 2002/0094459, 2002/0142196, 2003/0099876, 2005/0058882, 2006/0057437 and 2006/0147780 and in U.S. Pat. Nos. 5,599,640, 5,804,329, 6,544,877 and 6,773,470 the entire disclosures whereof are hereby incorporated by reference herein.

The surface area of the gas diffusion electrode of the present invention is not particularly limited. Usually, however, the surface area is at least about 0.5 cm², e.g., at least about 2 cm², at least about 5 cm², at least about 10 cm², at least about 20 cm² or at least about 30 cm². On the other hand, the surface area usually is not larger than about 500 cm², e.g., not larger than about 300 cm², not larger than about 200 cm², not larger than about 100 cm², not larger than about 75 cm² or not larger than about 50 cm².

The fuel cell and metal-air battery of the present invention can be used to supply electrical energy to a virtually unlimited number of electric and electronic devices. Non-limiting examples thereof are (cellular) phones, (portable) computers, PDAs, consumer electronics, (portable) medical devices and components and peripherals thereof. The fuel cell may also be used as a generator for emergency situations such as a power outage, as disclosed in U.S. patent application Ser. No. 11/475,063, the entire disclosure whereof is incorporated by reference herein.

### EXAMPLE 1

A powder mixture of 45% by weight of Timcal HSAG300 high surface area graphite comprising 10% by weight of Co, 45% by weight of Norit SX1G carbon powder and 10% by weight of Dyneon TF2055 PTFE powder is agglomerated at room temperature in a M-20 machine (IKA Works, Inc., Wilmington, N.C.) at 30 krpm for 3×40 seconds. The agglomerated mixture is passed through a calender using a gap of 345 μm between rollers of 65 mm in diameter to produce a web having a thickness of 442 μm. Thereafter the web and a 20×20 Ni mesh having a thickness of 200 μm (Haver & Boecker OHG, Germany) and being pre-coated with Timrex LB-1016 conductive coating are passed together through a calender having a gap of 213 μm between calendering rollers of 65 mm in diameter to result in a current collector-web composite having a thickness of 373 μm. A porous PTFE sheet (R167-7 produced by Saint Gobain, France) is then pressure laminated (˜3 kN; color densitometer reading Cyan—0.22+/−3) to the current collector-web composite to afford a gas diffusion electrode of the present invention having a thickness of 440 μm.

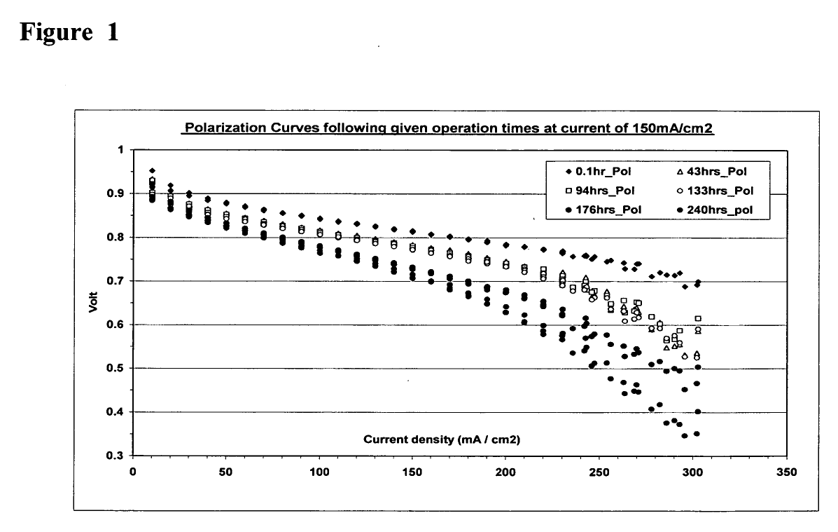

The polarization of the electrode is determined after different times of operation and the results are graphically represented in FIG. 1. FIG. 1 shows typical voltage-current characteristics at ambient temperature of the electrode so formed.

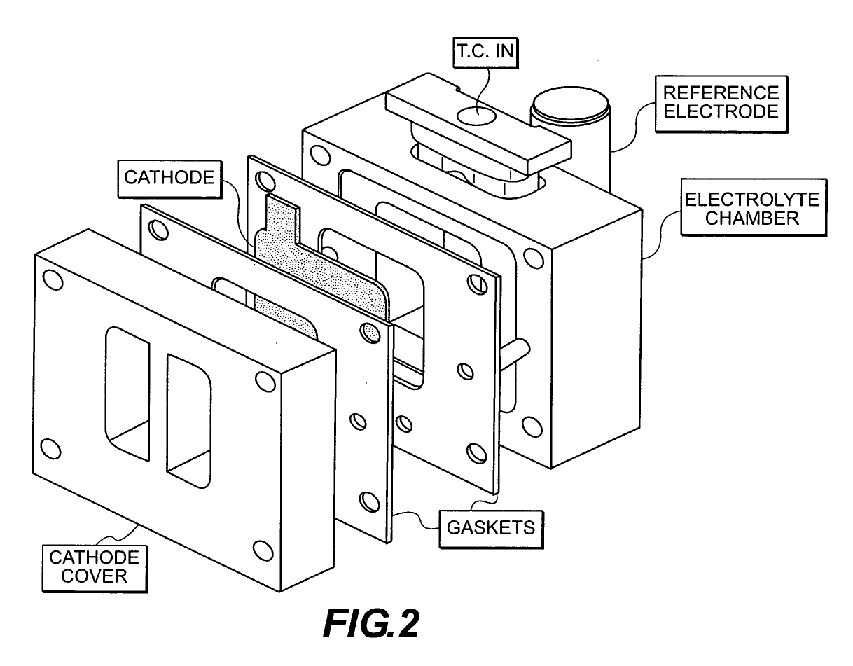

FIG. 2 shows a “Half Cell” device which is used to obtain the data represented in FIG. 1. In the device the cathode active area is 10 cm², the counter electrode is made of Ni and the cathode potential is measured with a reference hydrogen electrode (made by Gaskatel GmbH of Kassel, Germany). The cell is filled with 6.6 M KOH electrolyte. A thermocouple measures the temperature of the electrolyte during discharge. Discharge is controlled by a Maccor Test System (Maccor, Inc., Tulsa Okla.), recording current, voltage and temperature. The test protocol (which is repeated each time after replacing the electrolyte in the cell) is as follows:
1—Cell at rest potential for 2 min.
2—Galvanostatic step: 1 Amp for 20 sec.
3—Potentiostatic step: 0.535 V vs. Reference Hydrogen Electrode (RHE) until temperature reaches 40° C. (cell self-heating)
4—Rest step: 15 sec.
5—Galvanodynamic steps from 0 to 3 A (i.e. 0 to 300 mA·cm⁻²) with lower potential limit: 0.235 V vs. RHE. Galvanostatics Steps: each 0.1 A for 8 sec (polarization).
6—Rest step: 2 min.
7—Galvanostatic step: 1 A for 1 min.
8—Galvanostatic step: 1.5 A until next time of replacing the electrolyte.

### EXAMPLE 2

A powder mixture of 40% by weight of Timcal HSAG300 high surface area graphite comprising 10% by weight of Co, 40% by weight of Anthralur KC activated carbon (Donau Carbon Corporation, Springfield, N.J.) and 10% by weight of Dyneon TF2055 PTFE powder is agglomerated at room temperature in a M-20 machine (IKA Works, Inc., Wilmington, N.C.) at 30 krpm for 3×30 seconds. The agglomerated mixture is passed through a calender using a gap of 450 μm between rollers of 65 mm in diameter to produce a web having a thickness of 450 μm. Thereafter the web and a 20×20 Ni mesh having a thickness of 200 μm (Haver & Boecker OHG, Germany) and being pre-coated with Timrex LB-1016 conductive coating are passed together through a calender having a gap of 340 μm between calendering rollers of 65 mm in diameter to result in a current collector-web composite having a thickness of 450 μm. A porous PTFE sheet (R167-7 produced by Saint Gobain, France) is then pressure laminated (˜3 kN) to the current collector-web composite to afford a gas diffusion electrode of the present invention having a thickness of 510 μm.

### EXAMPLE 3

A powder mixture of 40% by weight of Timcal HSAG300 high surface area graphite comprising 10% by weight of Co, 53% by weight of Norit SX1G carbon powder and 7% by weight of Dyneon TF2055 PTFE powder is agglomerated at room temperature in a M-20 machine (IKA Works, Inc., Wilmington, N.C.) at 30 krpm for 3×60 seconds. The agglomerated mixture is passed through a calender using a gap of 240 μm between rollers of 65 mm in diameter to produce a web having a thickness of 360 μm. Thereafter the web and a 20×20 Ni mesh having a thickness of 200 μm (Haver & Boecker OHG, Germany) and being pre-coated with Timrex LB-1016 conductive coating are passed together through a calender having a gap of 175 μm between calendering rollers of 65 mm in diameter to result in a current collector-web composite having a thickness of 330 μm. A porous PTFE sheet (R167-7 produced by Saint Gobain, France) is then pressure laminated (˜3 kN) to the current collector-web composite to afford a gas diffusion electrode of the present invention having a thickness of 390 μm.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A substantially dry method of making a gas diffusion electrode, wherein the method comprises
(a) forming an intimate mixture of catalytically active carbon particles and particles of a wet-proofing agent into a web;
(b) combining under pressure the web of (a) with a current collector to form a current collector-web composite; and
(c) attaching a porous sheet of a fluorinated polymer to one side of the current collector-web composite of (b) to form a gas diffusion electrode.

2. The method of claim 1, wherein the method is carried out in a substantial absence of added solvent.

3. The method of claim 1, wherein the intimate mixture employed in (a) has been prepared by treating the catalytically active carbon particles and the fluorinated polymer particles in at least one of a milling machine, a chopping machine and a beating machine.

4. The method of claim 3, wherein the intimate mixture has been prepared in a substantial absence of added solvent.

5. The method of claim 1, wherein the catalytically active carbon particles comprise carbon particles which support a catalytically active material.

6. The method of claim 5, wherein the catalytically active material comprises at least one of Co, Mn and Ag.

7. The method of claim 5, wherein the catalytically active material is present in a concentration of from about 0.1% to 10% by weight, based on a total weight of the carbon particles and the catalytically active material.

8. The method of claim 1, wherein the catalytically active carbon particles have at least one of an average particle size of from about 1 μm to about 100 μm and a specific surface area of at least about 200 m²/g.

9. The method of claim 8, wherein the catalytically active carbon particles have at least one of an average particle size of from about 6 μm to about 50 μm and a specific surface area of from about 300 m²/g to about 1000 m²/g.

10. The method of claim 1, wherein the intimate mixture further comprises pore-forming particles having an average particle size of from about 1 μm to about 100 μm and a specific surface area of from about 500 m²/g to about 2000 m²/g.

11. The method of claim 10, wherein the pore-forming particles comprise electrically conductive particles.

12. The method of claim 11, wherein the electrically conductive particles comprise carbon particles.

13. The method of claim 1, wherein the particles of a wet-proofing agent comprise fluorinated polymer particles.

14. The method of claim 13, wherein the fluorinated polymer particles comprise particles of a fluorinated hydrocarbon polymer.

15. The method of claim 14, wherein the fluorinated hydrocarbon comprise at least one of a fluorinated ethylene and a fluorinated propylene.

16. The method of claim 15, wherein the fluorinated hydrocarbon comprises tetrafluoroethylene.

17. The method of claim 1, wherein the fluorinated polymer particles have an average particle size of from about 10 μm to about 500 μm.

18. The method of claim 1, wherein the intimate mixture of (a) comprises from about 30% to about 95% by weight of the catalytically active carbon particles and from about 5% to about 35% by weight of the particles of a wet-proofing agent, both based on a total weight of the mixture.

19. The method of claim 10, wherein the intimate mixture of (a) comprises up to about 65% by weight of the pore-forming particles.

20. The method of claim 1, wherein the web of (a) has a thickness of from about 0.2 mm to about 0.6 mm.

21. The method of claim 1, wherein the current collector employed in (b) comprises at least one of a metal mesh, a metal grid, a metal cloth and a metal foam.

22. The method of claim 21, wherein the current collector comprises Ni.

23. The method of claim 21, wherein the current collector comprises a mesh or cloth having a thickness of from about 0.12 mm to about 0.4 mm or a metal foam having a thickness of from about 0.5 mm to about 2 mm.

24. The method of claim 1, wherein (b) comprises passing the web and the current collector together through a calender.

25. The method of claim 1, wherein the current collector-web composite has a thickness of from about 0.2 mm to about 0.6 mm.

26. The method of claim 1, wherein the sheet of a fluorinated polymer comprises polytetraflurorethylene.

27. The method of claim 1, wherein the sheet of a fluorinated polymer has at least one of a thickness of from about 0.1 mm to about 0.35 mm and an average pore size of from about 0.05 μm to about 2 μm.

28. The method of claim 1, wherein the sheet of a fluorinated polymer is laminated to the current collector-web composite.

29. The method of claim 1, wherein the gas diffusion electrode of (c) has a thickness of from about 0.25 mm to about 0.75 mm.

30. A substantially dry method of making an air cathode for a fuel cell or a metal-air battery cell, wherein the method comprises
(a) forming a fibrillated mixture of, based on a total weight of the mixture,
(i) from about 40% to about 60% by weight of catalytically active carbon particles having at least one of an average particle size of from about 6 μm to about 50 μm and a specific surface area of from about 300 m²/g to about 1000 m²/g.
(ii) from about 5% to about 20% by weight of particles of a fluorinated hydrocarbon polymer, and
(iii) from about 40% to about 55% by weight of pore-forming carbon particles having at least one of an average particle size of from about 10 μm to about 50 μm and a specific surface area of from about 800 m²/g to about 1500 m²/g
into a web having a thickness of from about 0.35 mm to about 0.55 mm;
(b) calendering the web of (a) together with a current collector which comprises at least one of a metal mesh, a metal grid, a metal cloth and a metal foam to form a current collector-web composite having a thickness of from about 0.35 mm to about 0.5 mm; and
(c) laminating a porous PTFE sheet having at least one of a thickness of from about 0.15 mm to about 0.2 mm and an average pore size of from about 0.05 μm to about 2 μm to one side of the current collector-web composite of (b) to form an air cathode having a thickness of from about 0.35 mm to about 0.55 mm; the method being carried out in a substantial absence of solvent.

31. The method of claim 30, wherein the fibrillated mixture of (a) has been prepared by treating a mixture of particles (i) to (iii) in at least one of a milling machine, a chopping machine and a beating machine.

32. The method of claim 31, wherein the particles (i) comprise carbon particles which support a catalytically active metal.

33. The method of claim 32, wherein the catalytically active metal comprises at least one of Co, Mn and Ag.

34. The method of claim 33, wherein the catalytically active metal is present in a concentration of from about 0.1% to 10% by weight, based on a total weight of the carbon particles and the catalytically active metal.

35. The method of claim 30, wherein the fluorinated polymer particles comprise particles of a polymer of at least one of a fluorinated ethylene and a fluorinated propylene.

36. The method of claim 35, wherein the fluorinated polymer particles comprise polytetrafluoroethylene.

37. The method of claim 36, wherein the current collector comprises Ni.

38. A gas diffusion electrode which is obtainable by the method of claim 1.

39. The gas diffusion electrode of claim 38, wherein the electrode has a surface area of from about 0.5 cm² to about 200 cm².

40. A fuel cell which comprises the gas diffusion electrode of claim 38.

41. The fuel cell of claim 40, wherein the fuel cell is at least one of a direct liquid fuel cell and a portable fuel cell.

42. A metal-air battery which comprises the gas diffusion electrode of claim 38.

43. A method of supplying energy to an electrical device, wherein the method comprises connecting the device to a fuel cell or a metal-air battery which comprises the gas diffusion electrode of claim 38.
